(19) United States
(12) Patent Application Publication
(10) Pub. No.: US 2025/0112868 A1
(43) Pub. Date: Apr. 3, 2025

(54) TRANSMISSION OF DATA PACKET WITH DELAY INFORMATION TO AN INDUSTRIAL CONTROLLER

(71) Applicant: Telefonaktiebolaget LM Ericsson (publ), Stockholm (SE)

(72) Inventors: Ari KERÄNEN, Helsinki (FI); Jaime JIMÉNEZ, Espoo (FI); Peter DE BRUIN, Gammelstad (SE); Edgar RAMOS, Kirkkonummi (FI); Sara SANDBERG, Luleå (SE); Norbert REIDER, Tényö (HU); Roman CHIRIKOV, Stockholm (SE)

(21) Appl. No.: 18/833,123

(22) PCT Filed: Jan. 27, 2022
(86) PCT No.: PCT/SE2022/050081

§ 371 Date: Jul. 25, 2024

(51) Int. Cl. H04L 47/283; H04L 69/22

(52) U.S. Cl. CPC H04L 47/283; H04L 69/22

(57) ABSTRACT

Embodiments of the present disclosure provide a method for transmitting a data packet intended for an industrial controller. The method is performed by a primary network node in the wireless communication network. The method includes receiving a data packet from at least one industrial device. The method includes determining a delay time associated with the received data packet. The delay time is indicative of a delay of the received data packet occurred during transmission of the received data packet to the primary network node. The method further includes forming a data packet intended for the industrial controller. The method further includes transmitting the data packet intended for an industrial controller, to one or more secondary network nodes in the wireless communication network. The forming of the data packet intended for the industrial controller includes forming the data packet from the received data packet and the determined delay time.

### TECHNICAL FIELD

The present disclosure relates generally to an industrial environment. More particularly, it relates to methods, a primary network node, a secondary network node and computer program products for transmitting a data packet with delay information to the industrial controller.

### BACKGROUND

Industrial automation is becoming increasingly popular due to rapid development in sensors, control system, and other manufacturing techniques. In industrial automation, a low bounded latency is very important. Achieving the low bounded latency (e.g., below 10 ms delay with 99.99% reliability) is however costly in terms of spectral resources as it typically requires the use of a low modulation and coding scheme (MCS) with low spectral efficiency to ensure reliability.

A typical industrial application assumes an ideal network, without packet loss and minimum delay. These industrial systems were designed for wired communication where packet loss and delay are close to zero. Thus, in case a delay or packet loss is detected, the industrial application is stopped by the underlying communication layer. For example, a ProfiNet protocol tolerates only 3 missing consecutive packets, which means that using e.g., 2 ms cycle time, a 6+ ms gap in the packet arrival stops the application completely. Further, the industrial device deviates from its desired path due to the delay in the transmission of command messages to it. The average deviations in space seem to be small, i.e., in the range of few millimetres. However, even the small deviation is not acceptable for many industrial applications. For example, in a flexible industrial device control architecture where network imperfections that causes unexpected delay can have direct negative impact on the performance of the industrial device unless delay is compensated.

For example, referring to FIG. 1A, an industrial device control architecture comprising an industrial controller 108 and an industrial device 102 is illustrated. The industrial controller 108 generates a command message for controlling the industrial device 102 and transmits the command message to the industrial device 102 by using a command generator, a command executor, and a communication module. The command message is expected to be delivered to the industrial device 102 without any delay. However, due to network imperfection in the wireless communication network, an unexpected delay “D” has been introduced in the transmission of the command message to the industrial device 102. The industrial device 102 comprises a device controller 10 for controlling the industrial device 102 using the command messages. Due to the unexpected delay “D” caused by the wireless communication network, the industrial device 102 is not able to perform the assigned task with precision. Thus, the performance of the industrial device 102 may be affected due to the unexpected delay “d”.

To mitigate the above mentioned problem, the industrial controller 108 may add a timestamp to keep track of the delay during the transmission of data packets. However, the use of timestamp to keep track of delay may introduce an overhead for the wireless link in the transmission of the data packet. For example, a fixed-point 64-bit timestamp format which utilizes 32 bits for seconds and 32 bits for fractions of a second may be used for tracking the delay during the transmission of the data packet as depicted in FIG. 1B.

### SUMMARY

Consequently, there is a need for an improved method and arrangement for transmitting a data packet to the industrial controller that alleviates at least some of the above cited problems.

It is therefore an object of the present disclosure to provide a method, a primary network node, a secondary network node and a computer program transmitting a data packet intended for an industrial controller to mitigate, alleviate, or eliminate all or at least some of the above-discussed drawbacks of presently known solutions.

This and other objects are achieved by means of a method, a primary network node, a secondary network node, and a computer program product as defined in the appended claims. The term exemplary is in the present context to be understood as serving as an instance, example or illustration.

According to a first aspect of the present disclosure, a method for transmitting a data packet intended for an industrial controller is disclosed. The industrial controller is configured for executing an industrial application to control one or more industrial devices in an industrial environment. The method is performed by a primary network node in the wireless communication network. The method comprises receiving a data packet from at least one industrial device. The method comprises determining a delay time associated with the received data packet. The delay time being indicative of a delay of the received data packet occurred during transmission of the received data packet to the primary network node. The method further comprises forming a data packet intended for the industrial controller. The method further comprises transmitting the data packet intended for an industrial controller, to one or more secondary network nodes in the wireless communication network. The forming of the data packet intended for the industrial controller comprises forming the data packet from the received data packet and the determined delay time.

In some embodiments, the step of forming the data packet intended for the industrial controller comprises identifying a header extension of the received data packet and appending the delay time to the header extension of the received data packet.

In some embodiments, the header extension comprises one or more of an Internet Protocol, IP, header extension, Hypertext Transfer Protocol, HTTP, header extension and Constrained Application Protocol, CoAP, header extension.

In some embodiments, the step of determining a delay time associated with the data packet comprises acquiring a set of configured parameters associated with the primary network node and determining the delay time based on the set of configured parameters associated with the primary network node.

In some embodiments, the set of configured parameters comprises one or more of a queuing delay, a number of Hybrid Automatic Repeat Request, HARQ, retransmissions, a number of Radio Link Control, RLC, retransmissions, and an estimated delay per HARQ retransmission.

In some embodiments, the method further comprising obtaining information about change in the set of configured parameters associated with the primary network node and determining the delay time based on the information about the change in the set of configured parameters.

In some embodiments, the information about the change in the set of configured parameters comprises one or more of: detection of a handover event from the primary network node to another primary network node and detection of an increase in a number of industrial devices connected to the primary network node.

In some embodiments, the method further comprising determining that the delay time exceeds a pre-determined delay threshold and when it is determined that the delay time has exceeded the pre-determined delay threshold, transmitting a message to the industrial controller. The message comprises an indication that the delay time has exceeded the pre-determined delay threshold.

According to a second aspect of the present disclosure, a method for transmitting a data packet to an industrial controller is disclosed. The industrial controller is configured for executing an industrial application to control one or more industrial devices in an industrial environment. The method is performed a secondary network node among a plurality of secondary network nodes between a primary network node and the industrial controller, in a wireless communication network. The method comprises receiving, from the primary network node, a data packet comprising a delay time relating to a delay occurred during the transmission of the data packet to the primary network node. The method comprises determining a new delay time associated with the received data packet. The new delay time is indicative of delay occurred during the transmission of the data packet to the secondary network node. The method further comprises forming a data packet intended for the industrial controller. The method further comprises transmitting the data packet to the industrial controller in the wireless communication network. The forming of the data packet intended for the industrial controller comprises forming the data packet from the received data packet and the determined new delay time.

In some embodiments, the step of forming the data packet intended for the industrial controller comprising identifying a header extension of the received data packet and appending the new delay time to the header extension of the received data packet.

In some embodiments, the header extension comprises one or more of an Internet Protocol, IP, header extension, Hypertext Transfer Protocol, HTTP, header extension and Constrained Application Protocol, CoAP, header extension.

In some embodiments, the step of determining the new delay time associated with the data packet comprises acquiring a set of configured parameters associated with the secondary network node and determining the new delay time based on the set of configured parameters associated with the secondary network node.

In some embodiments, the set of configured parameters comprises one or more of a queuing delay, a number of Hybrid Automatic Repeat Request, HARQ, retransmissions, a number of Radio Link Control, RLC, retransmissions, and an estimated delay per HARQ retransmission.

In some embodiments, the method further comprising obtaining information about change in the set of configured parameters associated with the secondary network node and determining the new delay time based on the information about the change in the set of configured parameters.

In some embodiments, the information about the change in the set of configured parameters comprises one or more of: detection of a handover event from the secondary network node to another secondary network node and detection of an increase in a number of industrial devices connected to the secondary network node.

In some embodiments, the method further comprising determining that the new delay time exceeds a pre-determined delay threshold and when it is determined that the delay time has exceeded the pre-determined delay threshold, transmitting a message to the industrial controller. The message comprises an indication that the new delay time has exceeded the pre-determined delay threshold.

According to a third aspect of the present disclosure, an apparatus of a primary network node configured to operate in a wireless communication network for transmitting a data packet intended for an industrial controller is provided. The industrial controller is configured for executing an industrial application to control one or more industrial devices. The apparatus comprising controlling circuitry configured to cause reception of a data packet from at least one industrial device. The controlling circuitry is configured to cause determination of a delay time associated with the data packet. The delay time is indicative of a delay of the received data packet occurred during transmission of the received data packet to the primary network node. Further, the controlling circuitry is configured to cause formation of a data packet intended for the industrial controller. The controlling circuitry is configured to cause transmission of the data packet intended for an industrial controller, to one or more secondary network nodes in the wireless communication network. The forming of the data packet intended for the industrial controller comprises forming the data packet from the received data packet and the determined delay time.

A fourth aspect is a primary network node comprising the apparatus of the third aspect.

According to a fifth aspect of the present disclosure, an apparatus of a secondary network node among a plurality of secondary network nodes between a primary network node and the industrial controller configured to operate in a wireless communication network for transmitting a data packet to an industrial controller is provided. The industrial controller is configured for configured for executing an industrial application to control one or more industrial devices in an industrial environment. The apparatus comprising controlling circuitry configured to cause reception, from the primary network node, a data packet comprising a delay time relating to a delay occurred during transmission of the data packets to the primary network node. The controlling circuitry is configured to cause determination of a new delay time associated with the data packet. The new delay time is indicative of delay occurred during the transmission of the data packet to the secondary network node. Further, the controlling circuitry is configured to cause formation of a data packet intended for the industrial controller. The controlling circuitry is configured to cause transmission of the data packet to the industrial controller in the wireless communication network. The forming of the data packet intended for the industrial controller comprises forming the data packet from the received data packet and the determined new delay time.

A sixth aspect is a secondary network node comprising the apparatus of the fifth aspect.

According to a seventh aspect of the present disclosure, there is provided a computer program product comprising a non-transitory computer readable medium, having thereon a computer program comprising program instructions. The computer program is loadable into a data processing unit and configured to cause execution of the method according to the first and the second aspects when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for transmission of the data packet with the delay time to the industrial controller.

An advantage of some embodiments is that the delay time associated with the data packet is included with the data packet when it reaches the industrial controller. Thus, the industrial controller can generate the commands for the industrial device by considering the delay time.

An advantage of some embodiments is that the time-stamp information is not included to avoid large overhead on the wireless link.

An advantage of some embodiments is that the performance degradation or failed operations in the industrial environment can be mitigated.

An advantage of some embodiments is that the industrial devices perform the assigned task with precision.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1A and 1B discloses an example architecture of Industrial environment;

FIG. 2 discloses an example industrial environment according to some embodiments;

FIG. 3 discloses a signalling diagram illustrating example signalling according to some embodiments;

FIG. 4 is a flowchart illustrating example method steps according to some embodiments;

FIG. 5 is a flowchart illustrating example method steps according to some embodiments;

FIGS. 6A and 6B are graphs illustrating statistics of spatial and temporal deviations of the actual movement of the industrial device from the desired movement of the industrial device according to some embodiments;

FIG. 7 is a schematic block diagram illustrating an example apparatus according to some embodiments;

FIG. 8 is a schematic block diagram illustrating an example apparatus according to some embodiments; and

FIG. 9 discloses an example computing environment according to some embodiments.

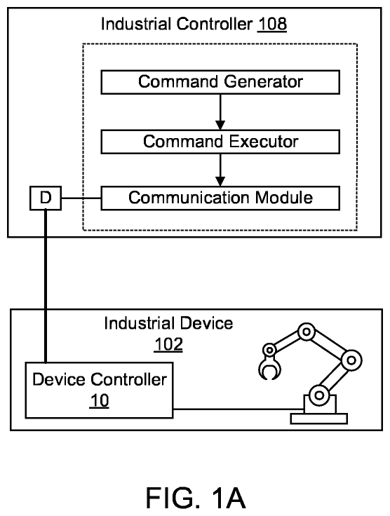

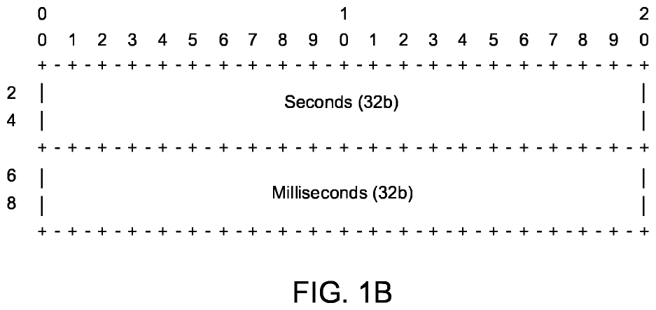

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

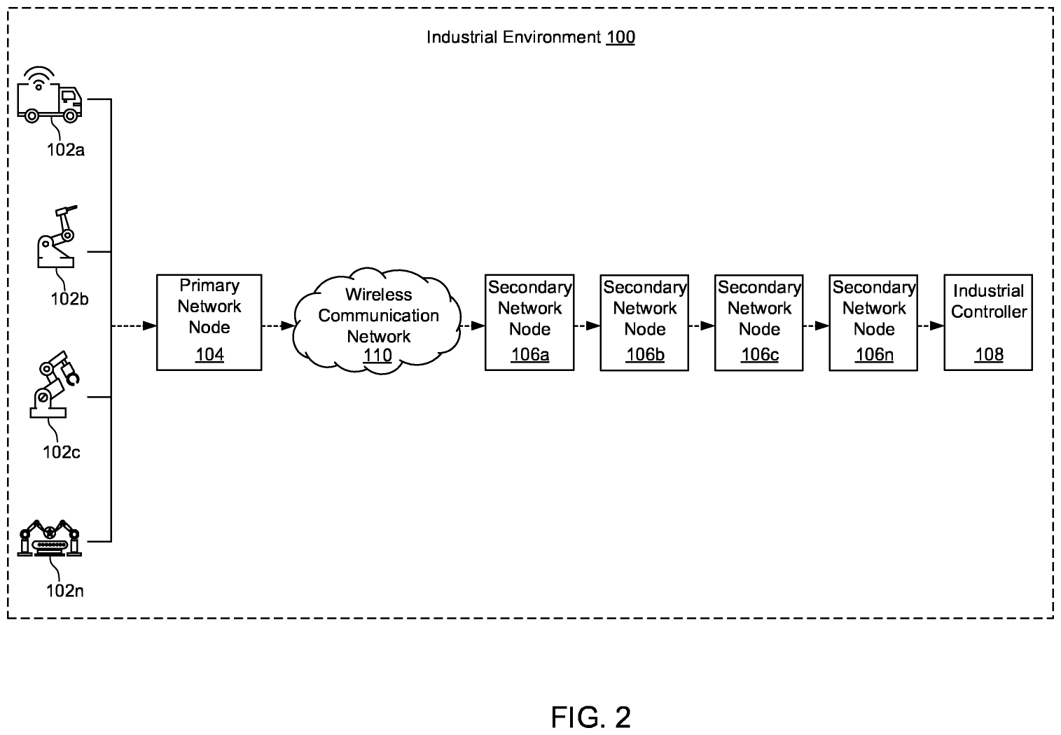

FIG. 2 discloses an industrial environment 100. Some of the examples of the industry environment 100 may include a factory, a manufacturing unit, guided robotic environment, etc. The industrial environment 100 comprises industrial devices 102a, 102b, 102c and so on to 102n, a primary network node 104, secondary network nodes 106a, 106b, 106c and so on to 106n, and an industrial controller 108. Each industrial device 102a-102n communicates with the industrial controller 108 through the primary network node 104 and the secondary network nodes 106a-106n in a wireless communication network 110. For example, the one or more industrial devices 102a-102n is configured to transmits data packets to the industrial controller 108 through the primary network node 104 and the secondary network nodes 106a-106n. The primary network node 104 may be a transceiver node that is adapted to transmit and receive the data packets. The primary network node 104 may be a radio access network comprising a plurality of base stations or evolved node base stations (not shown) or the internet using one or more suitable communication protocols for transmitting the data packets to the industrial controller 108. For example, the secondary network nodes 106a-106n may be the core network nodes which can include a primary gateway, P-GW, a secondary gateway, S-GW, or the like. The industrial controller 108 is configured to generate one or more command messages for controlling the industrial devices 102a-102n. Examples of the industrial devices 102a-102n may comprise Articulated Robots, Cartesian Robots, Selective Compliance Assembly Robot Arm, Delta robots, Polar robots, a 6-DOF robotic arm, collaborating robotic arms, Automated Guided Vehicles, AGVs, with omni-wheels, or other robotic devices. It should be noted that the industrial environment 100 is not limited to above-mentioned components, other components can also be present in the industrial environment 100 other than the component shown in the FIG. 2.

In some examples, the secondary network nodes 106a-106n may be one or more core network nodes. Each core node may be a networking device that is stationary or mobile and may also be referred to as a repeater, a modem, a router, a remote station, etc.

The primary network node 104 is configured to receive a data packet from the industrial device 102a-102n. The data packet may be delayed during the transmission from the industrial device 102a-102n to the primary network node 104. Further, the primary network node 104 transmits the data packet to the secondary network node 106a-106n. The data packet may be further delayed during the transmission from primary network node 104 to the secondary network node 106a-106n. Further, the secondary network node 106a-106n transmits the data packet to the industrial controller 108. The industrial controller 108 comprises an industrial application configured to generate one or more command messages intended for controlling the industrial device 102a-102n. The industrial application may not consider the unexpected delay caused during the transmission of the data packet from the industrial device 102a-102n to the industrial controller 108 through the primary network node 104 and the secondary network nodes 106a-106n in generation of the one or more command messages. This may result in the generation of undesired command messages intended for the industrial controllers 102a-102n.

Therefore, according to some embodiments of the present disclosure, the primary network node 104 implements a method for transmitting the data packet intended for the industrial controller 108. Further, the secondary network node 106a-106n implements a method transmitting a data packet to the industrial controller 108.

According to some embodiments of the present disclosure, the primary network node 104 receives the data packet from the industrial device 102a-102n. The data packet comprises information about the industrial device 102a-102n. Further, the primary network node 104 determines a delay time associated with the received data packet. The delay time is indicative of a delay of the received data packet occurred during transmission of the received data packet to the primary network node 104. The primary network node 104 forms a data packet intended for the industrial controller 108. Further, the primary network node 104 transmits the data packet to one or mode secondary network nodes 106a-106n in the wireless communication network 110. The forming of the data packet intended for the industrial controller 108 comprises forming the data packet from the received data packet and the determined delay time. For example, a new data packet is formed by appending the received data packet and the determined delay time during the transmission of the data packet to the primary network node 104.

According to some embodiments of the present disclosure, the secondary network node 106a-106n receives the data packet from the primary network node 104. The data packet comprises a delay time relating to a delay occurred during the transmission of the data packet to the primary network node 104. Further, the secondary network node 106a-106n determines a new delay time associated with the data packet. The new delay time is indicative of delay occurred during the transmission of the data packet to the secondary network node 106a-106n. Further, the secondary network node 106a-106n forms a data packet intended for the industrial controller 108. Further, the secondary network node 106a-106n transmits the data packet to industrial controller 108 in the wireless communication network 110. The forming of the data packet intended for the industrial controller 108 comprises forming the data packet from the received data packet and the determined new delay time. For example, a new data packet is formed by appending the received data packet and the determined new delay time during the transmission of the data packet to the secondary network node 106a-106n.

The industrial controller 108 may generate the one or more command messages by considering the delay time caused during the transmission of the data packet from the industrial device 102a-102n to the industrial controller 108. Thus, the industrial controller 108 generates the desired command messages intended for controlling the industrial devices 102a-102n in accordance with the delay time. Further, the data packet does not include the timestamps so that the large overhead on the wireless communication network 110 may be avoided. Thus, the performance degradation the industrial devices 102a-102n may be mitigated.

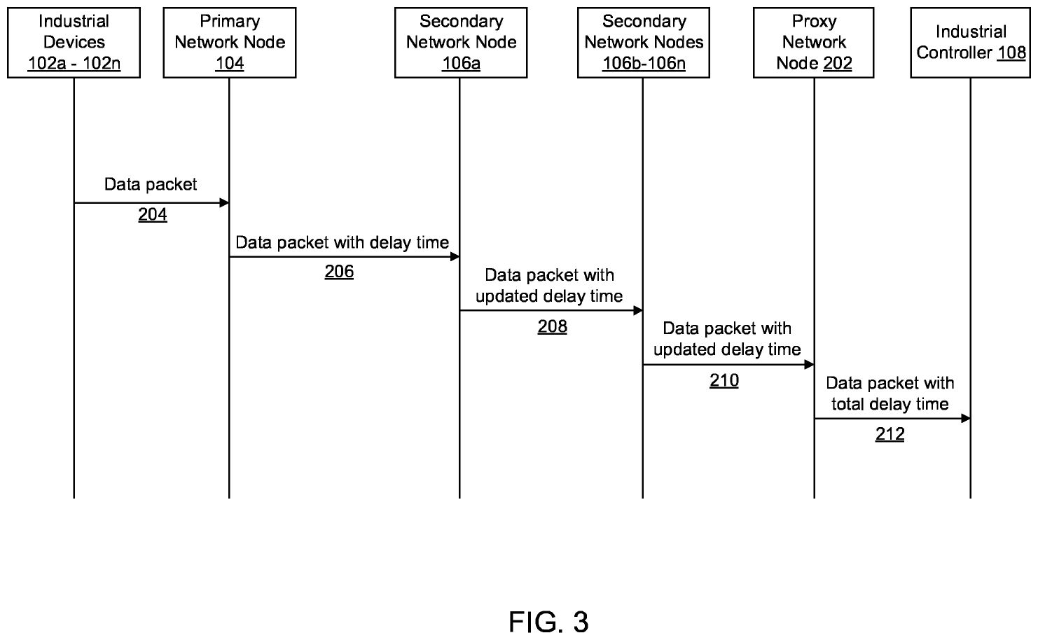

FIG. 3 is a signalling diagram illustrating example signalling for transmitting the data packet from the industrial devices 102a-102n in the industrial environment. The industrial environment comprises the one or more industrial devices 102a-102n, the primary network node 104, the one or more secondary network nodes 106a-106n, a proxy node 202, and the industrial controller 108.

The industrial devices 102a-102n transmit 204 a data packet to the primary network node 104. The data packet may comprises information about the industrial device 102a-102n. The data packet may be received at the primary network node 104 through the wireless communication network. A delay may be introduced during the transmission of the data packet between the industrial device 102a-102n and the primary network node 104. The primary network node 104 determines a delay time associated with the data packet. The delay time is indicative of a delay of the received data packet occurred during transmission of the received data packet to the primary network node 104. For example, the primary network node 104 acquires a set of configured parameters associated with the primary network node 104. The set of configured parameters may comprises one or more information related to constraints of a wireless channel between the industrial device 102a-102n and the primary network node 104. The set of configured parameters further comprise one or more of a queuing delay, a number of Hybrid Automatic Repeat Request, HARQ, retransmissions, a number of Radio Link Control, RLC, retransmissions, and an estimated delay per HARQ retransmission.

In some embodiments, the primary network node 104 obtains information about change in the set of configured parameters associated with the primary network node 104. The information about change in the set of configured parameters associated with the primary network node 104 may comprise detection of a handover event from the primary network node 104 to another primary network node and detection of an increase in a number of industrial devices 102a-102n connected to the primary network node 104. The primary network node 104 further determines the delay time based on the information about the change in the set of configured parameters. For example, when the primary network node 104 detects the handover event or increase in the network load, the delay time is determined so that the industrial controller 108 generates the one or more command messages to adapt such situation.

The primary network node 104 determines the delay time based on the set of configured parameters associated with the primary network node 104. For example, the primary network node 104 may analyze the set of configured parameters associated with the primary network node 104 and determine the delay time during the transmission from the industrial device 102a-102n to the primary network node 104.

Further, the primary network node 104 forms a data packet intended for the industrial controller 108. The forming of the data packet intended for the industrial controller 108 comprises forming the data packet from the received data packet and the determined delay time. For example, the primary network node 104 combines the received data packet and the determined delay time to form a new data packet.

In some embodiments, forming of the data packet comprises identifying a header extension of the data packet and appending the delay time to the header extension of the received packet. The header extension comprises one or more of an Internet Protocol, IP, header extension, Hypertext Transfer Protocol, HTTP, header extension, Constrained Application Protocol, CoAP, header extension, or the like. The IP header extension may be a proprietary header extension for the cellular network among a plurality of network nodes in the wireless communication network. The format of the IP header extension may follow RFC6564. The format of the HTTP header extensions may follow RFC7231 section 8.3. The CoAP header extension may follow RFC7252 section 3.1. The value of the header extension may comprise a small integer value that provides the current determined delay time the packet has experienced in milliseconds (for high-precision use cases microsecond resolution, or a tradeoff with the value being e.g., 1/10th of milliseconds or a floating-point value).

The primary network node 104 transmits 206 the data packet to a secondary network node 106a in the wireless communication network. For example, the primary network node 104 transmits the data packet including the delay time to one of the secondary network nodes 106a-106n. The secondary network node 106a may be an intermediate network node in a path from the primary network node 104 to the industrial controller 108.

The secondary network node 106a receives the data packet including the delay time from the primary network node 104. A delay may be introduced during the transmission of the data packet between the primary network node 104 the secondary network node 106a. The secondary network node 106a determines a new delay time associated with the data packet. The new delay time is indicative of delay occurred during the transmission of the data packet to the secondary network node 106a. For example, the secondary network node 106a acquires a set of configured parameters associated with the secondary network node 106a. The set of configured parameters may comprises one or more information related to constraints of a wireless channel between the primary network node 104 and the secondary network node 106a.

In some embodiments, the secondary network node 106a obtains information about change in the set of configured parameters associated with the secondary network node 106a. The information about change in the set of configured parameters associated with the secondary network node 106a may comprise detection of a handover event from the secondary network node 106a to another secondary network nodes 106b-106n and detection of an increase in a number of industrial devices 102a-102n connected to the secondary network node 106a. The secondary network node 106a further determines the new delay time based on the information about the change in the set of configured parameters. For example, when the secondary network node 106a detects the handover event or increase in the network load, the delay time is determined so that the industrial controller 108 generates the one or more command messages to adapt such situation.

The secondary network node 106a determines the new delay time based on the set of configured parameters associated with the secondary network node 106a. For example, the secondary network node 106a may analyze the set of configured parameters associated with the secondary network node 106a and determine the new delay time during the transmission from the primary network node 104 and the secondary network node 106a.

Further, the secondary network node 106a forms a data packet intended for the industrial controller 108. The forming of the data packet intended for the industrial controller 108 comprises forming the data packet from the received data packet and the determined delay time. For example, the secondary network node 106a combines the received data packet and the determined new delay time to form a new data packet.

In some embodiments, forming of the data packet comprises identifying a header extension of the data packet and appending the delay time to the header extension of the received packet. The header extension comprises one or more of an Internet Protocol, IP, header extension, Hypertext Transfer Protocol, HTTP, header extension, Constrained Application

Protocol, CoAP, header extension, or the like.

The secondary network node 106a transmits 208 the data packet to other secondary network node 106b-106n in the wireless communication network. For example, the secondary network node 106a may transmit the data packet including the delay time to one of the secondary network nodes 106b-106n. The secondary network nodes 106b-106n may be intermediate network nodes in a path from the secondary network node 106a to the industrial controller 108.

Each of the secondary network nodes 106b-106n determines the delay time associated with the data packet during the transmission between each secondary nodes 106b-106n. Further, the secondary network node 106b-106n transmits 210 the data packet to a proxy network node 202. The proxy network node 202 receives the data packet including the delay time appended by the primary network node 104 and each secondary network node 106a-106n. The proxy network node 202 extracts the delay time from the data packet and appends the delay time to an application layer header of the data packet.

Further, the proxy network node 202 transmits 212 the data packet to the industrial controller 108. The data packet includes the delay time appended by the primary network node 104 and each secondary network node 106a-106n. Thus, the data packet includes the total delay time occurred during the transmission from the industrial device 102a-102n, the primary network node 104, the secondary network nodes 106a-106n, and the industrial controller 108.

The industrial controller 108 receives the data packet from the proxy network node 202. Further, the industrial controller 108 extracts the delay time from the data packet. The industrial application executed in the industrial controller 108 generates the one or more command messages in accordance with the delay time. For example, the industrial application may discard the data packet when the delay time associated with the data packet exceeds the threshold delay value.

In view of one or more embodiments, the industrial controller 108 may generate the one or more command messages by considering the delay time caused during the transmission of the data packet from the industrial device 102a-102n, the primary network node 104, the secondary network nodes 106a-106n, and the industrial controller 108. Thus, the industrial controller 108 generates the desired command messages intended for controlling the industrial devices 102a-102n. Further, the data packet does not include the timestamps so that the large overhead on the wireless communication network 110 may be avoided. Thus, the performance degradation the industrial devices 102a-102n may be mitigated.

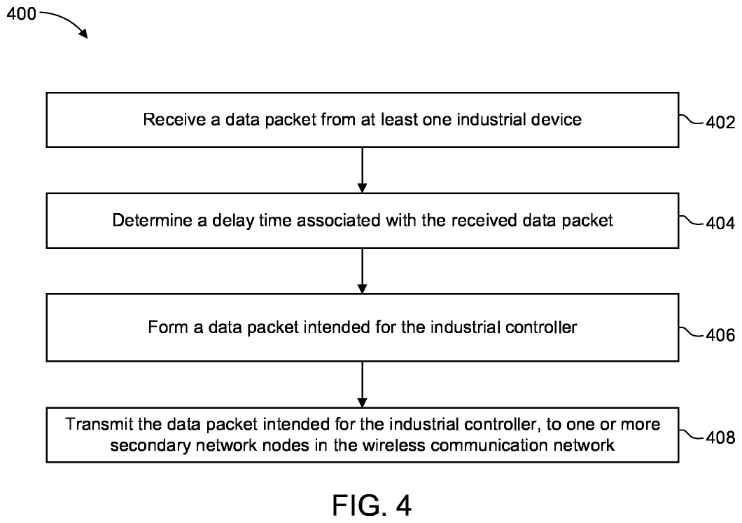

FIG. 4 is a flowchart illustrating example method steps of a method 400 performed by the primary network node in the wireless communication network for transmitting a data packet intended for the industrial controller.

At step 402, the method 400 comprises receiving a data packet from at least one industrial device. The data packet may comprise information about the industrial device. For example, the information comprises one or more of a position of the industrial device, a velocity by which the industrial device is currently moving, a type of the industrial device, or the like.

At step 404, the method 400 comprises determining a delay time associated with the data packet. The delay time is indicative of a delay of the received data packet occurred during transmission of the received data packet to the primary network node. The primary network node determines the delay time based on the set of configured parameters associated with the primary network node. For example, the primary network node acquires the set of configured parameters associated with the primary network node. Further, the primary network node determines the delay time based on the acquired set of configured parameters associated with the primary network node. The set of configured parameters comprises one or more of the queuing delay, the number of HARQ retransmissions, a number of RLC retransmissions, and an estimated delay per HARQ retransmission.

In some embodiments, the primary network node obtains the information about change in the set of configured parameters associated with the primary network node. The primary network node determines the delay time based on the information about the change in the set of configured parameters. The information about the change in the set of configured parameters comprises one or more of detection of a handover event from the primary network node to another primary network node and detection of an increase in a number of industrial devices connected to the primary network node.

At step 406, the method 400 comprises forming a data packet intended for the industrial controller. The forming of the data packet intended for the industrial controller 108 comprises forming the data packet from the received data packet and the determined delay time. The primary network node forms the data packet by appending the received data packet and the determined delay time. For example, the primary network node identifies a header extension of the data packet. The header extension comprises one or more of an Internet Protocol, IP, header extension, Hypertext Transfer Protocol, HTTP, header extension and Constrained Application Protocol, CoAP, header extension. Further, the primary network node appends the delay time to the header extension of the received data packet to form the data packet intended for the industrial controller.

At step 408, the method 400 comprises transmitting the data packet to one or more secondary network nodes in the wireless communication network. For example, the primary network node transmits the data packet comprising the delay time associated with the data packet.

In some embodiments, the primary network node determines that the delay time exceeds a pre-determined delay threshold. When it is determined that delay time has exceeded the pre-determined delay threshold, the primary network node transmits a message to the industrial controller. The messages comprises an indication that the delay time has exceeded the pre-determined delay threshold.

In some embodiments, the primary network node determines a latency requirement for the data packet. The primary network node further identifies one or more sources which cause the delay in the transmission of the data packet between the industrial device and the primary network node. Further, the primary network node determines whether the delay time caused by the identified sources exceeds the latency requirement of the data packet. When the delay caused by the identified sources exceeds the latency requirement of the data packet, the primary network node transmits an alert message to the industrial controller. The alert message comprises an indication that the delay caused by the identified sources exceeds the latency requirement of the data packet.

In some embodiments, the primary network node determines whether HARQ retransmission has been started or not. When the HARQ retransmission has been started, the primary network node transmits a notification to the industrial controller indicating that the HARQ retransmission has been started.

The delay time caused during the transmission of the data packet from the industrial device to the primary network node has been included in the data packet. Thus, the industrial controller may generate the desired command messages intended for controlling the industrial devices in accordance with the delay time. Further, the data packet does not include the timestamps so that the large overhead on the wireless communication network may be avoided. Thus, the performance degradation the industrial devices may be mitigated.

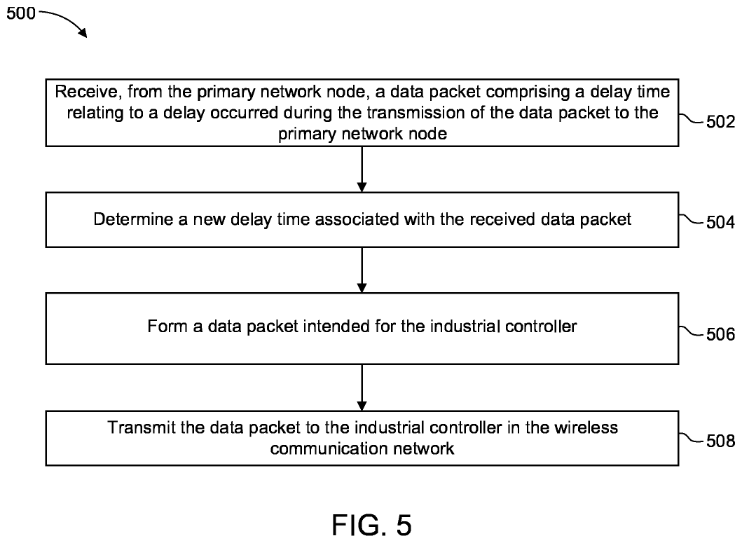

FIG. 5 is a flowchart illustrating example method steps of a method 500 performed by the secondary network node in the wireless communication network for transmitting a data packet to the industrial controller.

At step 502, the method 500 comprises receiving, from the primary network node, a data packet comprising a delay time relating to a delay occurred during the transmission of the data packet to the primary network node. For example, the secondary network node receives the data packet appended with the delay time occurred during the transmission of the data packets to the primary network node.

At step 504, the method 500 comprises determining a new delay time associated with the data packet. The new delay time is indicative of delay occurred during the transmission of the data packet to the secondary network node. The secondary network node determines the new delay time based on the set of configured parameters associated with the secondary network node. For example, the secondary network node acquires the set of configured parameters associated with the secondary network node. Further, the secondary network node determines the new delay time based on the acquired set of configured parameters associated with the secondary network node. The set of configured parameters comprises one or more of the queuing delay, the number of HARQ retransmissions, a number of RLC retransmissions, and an estimated delay per HARQ retransmission.

In some embodiments, the secondary network node obtains the information about change in the set of configured parameters associated with the secondary network node. The secondary network node determines the delay time based on the information about the change in the set of configured parameters. The information about the change in the set of configured parameters comprises one or more of detection of a handover event from the secondary network node to another secondary network node and detection of an increase in a number of industrial devices connected to the secondary network node.

At step 506, the method 500 comprises forming a data packet intended for the industrial controller. The forming of the data packet intended for the industrial controller comprises forming the data packet from the received data packet and the determined new delay time. The secondary network node forms the data packet by appending the received data packet and the determined delay time. For example, the secondary network node identifies the header extension of the data packet. The header extension comprises one or more of an Internet Protocol, IP, header extension, Hypertext Transfer Protocol, HTTP, header extension and Constrained Application Protocol, CoAP, header extension. Further, the secondary network node appends the delay time to the header extension of the received data packet to form the data packet intended for the industrial controller.

At step 508, the method 500 comprises transmitting the data packet to the industrial controller in the wireless communication network. For example, the secondary network node transmits the data packet comprising the delay time associated with the data packet.

In some embodiments, the secondary network node determines that the new delay time exceeds a pre-determined delay threshold. When it is determined that the new delay time has exceeded the pre-determined delay threshold, the secondary network node transmits a message to the industrial controller. The messages comprises an indication that the new delay time has exceeded the pre-determined delay threshold.

In some embodiments, the secondary network node determines a latency requirement for the data packet. The secondary network node further identifies one or more sources which cause the delay in the transmission of the data packet between the industrial device and the secondary network node. Further, the secondary network node determines whether the delay caused by the identified sources exceeds the latency requirement of the data packet. When the delay caused by the identified sources exceeds the latency requirement of the data packet, the secondary network node transmits an alert message to the industrial controller. The alert message comprises an indication that the delay caused by the identified sources exceeds the latency requirement of the data packet.

In some embodiments, the secondary network node determines whether HARQ retransmission has been started or not. When the HARQ retransmission has been started, the secondary network node transmits a notification to the industrial controller indicating that the HARQ retransmission has been started.

The new delay time caused during the transmission of the data packet from the primary network node to the secondary network node has been included in the data packet. Thus, the industrial controller may generate the desired command messages intended for controlling the industrial devices in accordance with the new delay time. Further, the data packet does not include the timestamps so that the large overhead on the wireless communication network may be avoided. Thus, the performance degradation the industrial devices may be mitigated.

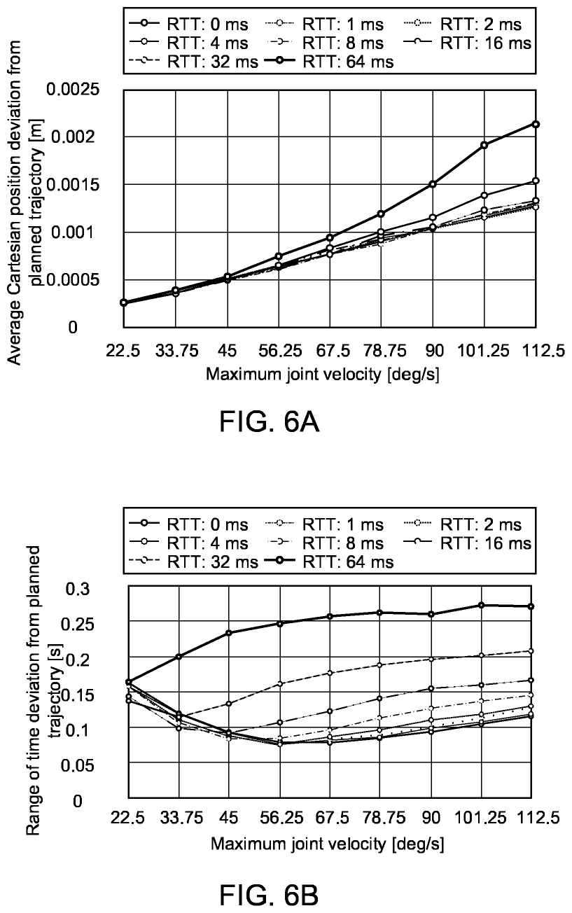

FIGS. 6A and 6B are graphs illustrating statistics of spatial and temporal deviations of the actual movement of the industrial device from the desired movement of the industrial device. FIG. 6A illustrates a graph of average Cartesian position deviation from the desired movement of the industrial device for different delay time. For example, the graph illustrates the deviation of position of the industrial device when the delay time has not been considered from the position of the industrial device when the delay time has been considered.

FIG. 6B illustrates a graph of range of time deviation from the desired movement of the industrial device for different delay time. For example, the graph illustrates the deviation of range of time of the industrial device when the delay time has not been considered from the range of time of the industrial device when the delay time has been considered.

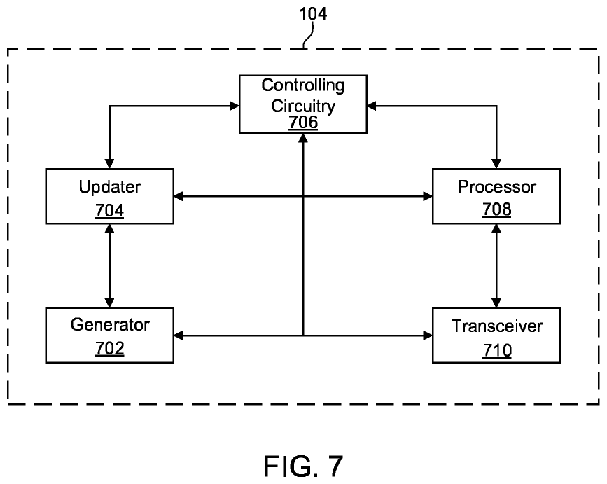

FIG. 7 is an example schematic diagram showing an apparatus 104. The apparatus 104 may e.g. be comprised in a primary network node. The apparatus 104 is capable of transmitting the data packet intended for the industrial controller and may be configured to cause performance of the method 400 for transmitting the data packet intended for the industrial controller.

According to at least some embodiments of the present invention, the apparatus 104 in FIG. 7 comprises one or more modules. These modules may e.g. be a generator 702, an updater 704, a controlling circuitry 706, a processor 708, and a transceiver 710. The controlling circuitry 706, may in some embodiments be adapted to control the above mentioned modules.

The generator 702, the updater 704, the processor 708, and the transceiver 710 as well as the controlling circuitry 706, may be operatively connected to each other.

Optionally, the transceiver 710 may be adapted to receive a data packet from the industrial device and transmit the data packet to one or more secondary network nodes in the wireless communication network.

As described above, the various ways of transmitting a data packet intended for an industrial controller, a few of which have been mentioned above in connection to the explanation of FIG. 4.

The controlling circuitry 706 may be adapted to control the steps as executed by the primary network node 104. For example, the controlling circuitry 706 may be adapted to determine the delay time associated with the data packet (as described above in conjunction with the method 400 and FIG. 4).

Further, the processor 708 is adapted to perform the method 400 and FIG. 4 in conjunction with the controlling circuitry 706.

The generator 702 is adapted to form a data packet intended for the industrial controller.

Furthermore, the updater 704 is adapted to update the data packet by including the delay time.

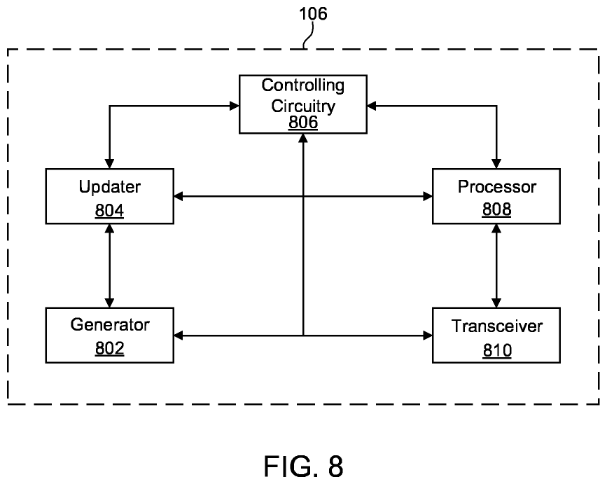

FIG. 8 is an example schematic diagram showing an apparatus 106. The apparatus 106 may e.g. be comprised in one or more secondary network nodes. The apparatus 106 is capable of transmitting the data packet to the industrial controller and may be configured to cause performance of the method 500 for transmitting the data packet to the industrial controller.

According to at least some embodiments of the present invention, the apparatus 106 in FIG. 8 comprises one or more modules. These modules may e.g. be a generator 802, an updater 804, a controlling circuitry 806, a processor 808, and a transceiver 810. The controlling circuitry 806, may in some embodiments be adapted to control the above mentioned modules.

The generator 802, the updater 804, the processor 808, and the transceiver 810 as well as the controlling circuitry 806, may be operatively connected to each other.

Optionally, the transceiver 810 may be adapted to receive a data packet from the industrial device and transmit the data packet to one or more secondary network nodes in the wireless communication network.

As described above, the various ways of transmitting a data packet intended for an industrial controller, a few of which have been mentioned above in connection to the explanation of FIG. 5.

The controlling circuitry 806 may be adapted to control the steps as executed by the network node 106. For example, the controlling circuitry 806 may be adapted to determine the delay time associated with the data packet (as described above in conjunction with the method 500 and FIG. 5).

Further, the processor 808 is adapted to perform the method 500 and FIG. 5 in conjunction with the controlling circuitry 806.

The generator 802 is adapted to form a data packet intended for the industrial controller.

Furthermore, the updater 804 is adapted to update the data packet by including the delay time.

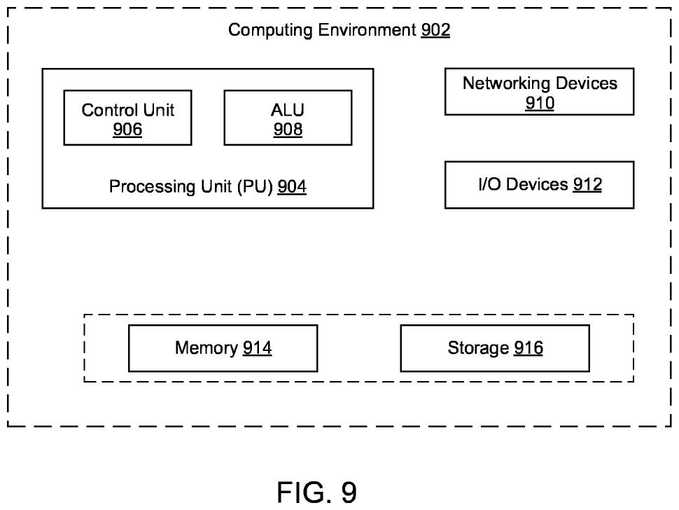

FIG. 9 illustrates an example computing environment 900 implementing a method and the network node and the UE as described in FIGS. 4 and 5. As depicted in FIG. 9, the computing environment 900 comprises at least one processing unit 902 that is equipped with a control unit 904 and an Arithmetic Logic Unit (ALU) 906, a plurality of networking devices 908 and a plurality Input output, I/O devices 910, a memory 912, and a storage 914. The processing unit 902 may be responsible for implementing the method described in FIGS. 4 and 5. For example, the processing unit 902 may in some embodiments be equivalent to the processor of the network node and the UE described above in conjunction with the FIGS. 4 and 5. The processing unit 902 is capable of executing software instructions stored in memory 912. The processing unit 902 receives commands from the control unit 904 in order to perform its processing. Further, any logical and arithmetic operations involved in the execution of the instructions are computed with the help of the ALU 906.

The computer program is loadable into the processing unit 902, which may, for example, be comprised in an electronic apparatus (such as a UE or a network node). When loaded into the processing unit 902, the computer program may be stored in the memory 912 associated with or comprised in the processing unit 902. According to some embodiments, the computer program may, when loaded into and run by the processing unit 902, cause execution of method steps according to, for example, any of the methods illustrated in FIGS. 4 and 5 or otherwise described herein.

The overall computing environment 900 may be composed of multiple homogeneous and/or heterogeneous cores, multiple CPUs of different kinds, special media and other accelerators. Further, the plurality of processing unit 902 may be located on a single chip or over multiple chips.

The algorithm comprising of instructions and codes required for the implementation are stored in either the memory 912 or the storage 914 or both. At the time of execution, the instructions may be fetched from the corresponding memory 912 and/or storage 914, and executed by the processing unit 902.

In case of any hardware implementations various networking devices 508 or external I/O devices 910 may be connected to the computing environment to support the implementation through the networking devices 908 and the I/O devices 910.

The embodiments disclosed herein can be implemented through at least one software program running on at least one hardware device and performing network management functions to control the elements. The elements shown in FIG. 9 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method for transmitting a data packet intended for an industrial controller, the industrial controller being configured for executing an industrial application to control one or more industrial devices in an industrial environment, the method being performed by a primary network node in a wireless communication network, the method comprising:
receiving a data packet from at least one industrial device;
determining a delay time associated with the received data packet, the delay time being indicative of a delay of the received data packet occurred during transmission of the received data packet to the primary network node;
forming a data packet intended for the industrial controller; and
transmitting the data packet intended for an industrial controller, to one or more secondary network nodes in the wireless communication network,
wherein the forming of the data packet intended for the industrial controller comprises forming the data packet from the received data packet and the determined delay time.

2. The method according to claim 1, wherein the forming the data packet intended for the industrial controller comprises:
identifying a header extension of the received data packet; and
appending the delay time to the header extension of the received data packet.

3. The method according to claim 2, wherein the header extension comprises one or more of an Internet Protocol (IP), header extension, Hypertext Transfer Protocol (HTTP), header extension and Constrained Application Protocol (CoAP) header extension.

4. The method according to claim 1, wherein the of determining the delay time associated with the received data packet comprises:
acquiring a set of configured parameters associated with the primary network node; and
determining the delay time based on the set of configured parameters associated with the primary network node.

5. The method according to claim 4, wherein the set of configured parameters comprises one or more of a queuing delay, a number of Hybrid Automatic Repeat Request (HARQ) retransmissions, a number of Radio Link Control (RLC) retransmissions, and an estimated delay per HARQ retransmission.

6. The method according to claim 4, further comprising:
obtaining information about change in the set of configured parameters associated with the primary network node; and
determining the delay time based on the information about the change in the set of configured parameters.

7. The method according to claim 6, wherein the information about the change in the set of configured parameters comprises one or more of:
detection of a handover event from the primary network node to another primary network node; and
detection of an increase in a number of industrial devices connected to the primary network node.

8. The method according to claim 1, further comprising:
determining that the delay time exceeds a pre-determined delay threshold; and
when it is determined that the delay time has exceeded the pre-determined delay threshold, transmitting a message to the industrial controller, the message comprising an indication that the delay time has exceeded the pre-determined delay threshold.

9. A method for transmitting a data packet to an industrial controller, the industrial controller being configured for executing an industrial application control one or more industrial devices in an industrial environment, the method being performed by a secondary network node among a plurality of secondary network nodes between a primary network node and the industrial controller, in a wireless communication network, the method comprising:
receiving, from the primary network node, a data packet comprising a delay time relating to a delay occurred during the transmission of the data packet to the primary network node;
determining a new delay time associated with the received data packet, the new delay time being indicative of delay occurred during the transmission of the data packet to the secondary network node;
forming a data packet intended for the industrial controller; and
transmitting the data packet to the industrial controller in the wireless communication network,
wherein the forming of the data packet intended for the industrial controller comprises forming the data packet from the received data packet and the determined new delay time.

10. The method according to claim 9, wherein the forming the data packet intended for the industrial controller comprises:
identifying a header extension of the received data packet; and
appending the new delay time to the header extension of the received data packet.

11. The method according to claim 10, wherein the header extension comprises one or more of an Internet Protocol (IP), header extension, Hypertext Transfer Protocol (HTTP), header extension and Constrained Application Protocol (CoAP) header extension.

12. The method according to claim 9, wherein the of determining the new delay time associated with the received data packet comprises:
acquiring a set of configured parameters associated with the secondary network node; and
determining the new delay time based on the set of configured parameters associated with the secondary network node.

13. The method according to claim 12, wherein the set of configured parameters comprises one or more of a queuing delay, a number of Hybrid Automatic Repeat Request (HARQ) retransmissions, a number of Radio Link Control (RLC) retransmissions, and an estimated delay per HARQ retransmission.

14. The method according to claim 12, further comprising:
obtaining information about change in the set of configured parameters associated with the secondary network node; and
determining the new delay time based on the information about the change in the set of configured parameters.

15. The method according to claim 14, wherein the information about the change in the set of configured parameters comprises one or more of:
detection of an handover event from the secondary network node to another secondary network node; and
detection of an increase in a number of industrial devices connected to the secondary network node.

16. The method according to claim 9, further comprising:
determining that the new delay time exceeds a pre-determined delay threshold; and
when it is determined that the new delay time has exceeded the pre-determined delay threshold, transmitting a message to the industrial controller, the message comprising an indication that the new delay time has exceeded the pre-determined delay threshold.

17. An apparatus of a primary network node configured to operate in a wireless communication network for transmitting a data packet intended for an industrial controller, the industrial controller being configured for executing an industrial application to control one or more industrial devices in an industrial environment, the apparatus comprising controlling circuitry configured to cause:
reception of a data packet from at least one industrial device;
determination of a delay time associated with the received data packet, the delay time being indicative of a delay of the received data packet occurred during transmission of the received data packet to the primary network node;
formation of a data packet intended for the industrial controller; and
transmission of the data packet intended for an industrial controller, to one or more secondary network nodes in the wireless communication network,
wherein the forming of the data packet intended for the industrial controller comprises forming the data packet from the received data packet and the determined delay time.

18-25. (canceled)

26. An apparatus of a secondary network node among a plurality of secondary network nodes between a primary network node and the industrial controller configured to operate in a wireless communication network for transmitting a data packet to an industrial controller, the industrial controller being configured for executing an industrial application to control one or more industrial devices in an industrial environment, the apparatus comprising controlling circuitry configured to cause:
reception, from the primary network node, a data packet comprising a delay time relating to a delay occurred during transmission of the data packets to the primary network node;
determination of a new delay time associated with the received data packet, the new delay time being indicative of delay occurred during the transmission of the data packet to the secondary network node;
formation of a data packet intended for the industrial controller; and
transmission of the data packet to the industrial controller in the wireless communication network,
wherein the forming of the data packet intended for the industrial controller comprises forming the data packet from the received data packet and the determined new delay time.

27-35. (canceled)
